(19) United States
(12) Patent Application Publication
(10) Pub. No.: US 2026/0332602 A1
(43) Pub. Date: Oct. 22, 2026

(54) AI-DRIVEN ADAPTIVE ACCESS CONTROL FOR MULTI-CLOUD SECURITY AND PERMISSION MANAGEMENT

(71) Applicant: Palo Alto Networks, Inc., Santa Clara, CA (US)

(72) Inventors: Anurag Reddy Ekkati, Lathrop, CA (US); Abishek Kumar Karuppasamy, Dublin, CA (US); PradeepKumar Vijaya Kumar, Dublin, CA (US); Ramesh Nampelly, Livermore, CA (US); Chiranjeevisantosh Madugundi, Pleasanton, CA (US)

(21) Appl. No.: 19/183,378

(22) Filed: Apr. 18, 2025

(51) Int. Cl. H04L 9/40; G06N 5/022

(52) U.S. Cl. CPC H04L 63/108; G06N 5/022; H04L 63/105

(57) ABSTRACT

The present application discloses a method, system, and computer system for dynamically generating and management permissions for multi-cloud service and/or infrastructure resources. The method includes: (i) determining, using an AI-powered dynamic decision-making model, access decisions for user authorization for each of a plurality of cloud providers for an enterprise, and (ii) automatically provisioning access to a user based on the determined access decisions for user authorization for each of the plurality of cloud providers.

### BACKGROUND OF THE INVENTION

In modern computing environments, organizations increasingly rely on cloud-based services and distributed network infrastructures to support their operations. Access management in these environments presents significant challenges, particularly as enterprises adopt multi-cloud strategies that involve diverse cloud providers, each with unique identity and access management (IAM) frameworks. Traditionally, access control mechanisms have relied on static configurations and predefined policies, which require manual intervention from administrators to grant, modify, or revoke permissions. This approach introduces inefficiencies, particularly in dynamic environments where resource configurations, user roles, and access requirements frequently change. Furthermore, excessive or long-lived permissions often result in security vulnerabilities, such as unauthorized access and compliance risks.

### BRIEF DESCRIPTION OF THE DRAWINGS

Various embodiments of the invention are disclosed in the following detailed description and the accompanying drawings.

FIG. 1 is a block diagram of an environment for managing permissions to resources in an enterprise network according to various embodiments.

FIG. 2 is a block diagram of an environment for managing permissions to resources in an enterprise network according to various embodiments

FIG. 3 is a sequence diagram of a method for dynamically provisioning access to network resources according to various embodiments.

FIG. 4 is a flow diagram of a method for determining the access specific to a cloud provider and provisioning the access according to various embodiments.

FIG. 5 is a flow diagram of a method for determining a query context according to various embodiments.

FIG. 6 is a flow diagram of a method for determining a query context according to various embodiments.

FIG. 7A is an example of a user access request according to various embodiments.

FIG. 7B is an example of a prompt used in connection with obtaining a query intent according to various embodiments.

FIG. 7C is an example of structured data for the query intent according to various embodiments.

FIG. 7D is an example of structured data for the query of an inventory database based on the query intent according to various embodiments.

FIG. 7E is an example of a prompt in connection with obtaining a dynamically generated access policy according to various embodiments.

FIG. 7F is an example of a dynamically generated access policy according to various embodiments.

FIG. 8 is a flow diagram of a method for generating an access policy according to various embodiments.

FIG. 9 is a flow diagram of a method for obtaining an access request intent according to various embodiments.

FIG. 10 is a flow diagram of a method for obtaining contextual data according to various embodiments.

FIG. 11 is a flow diagram of a method for storing contextual data into a data store based on information stored in an enterprise network knowledge base according to various embodiments.

FIG. 12 is a flow diagram of a method for obtaining approvals for granting access to a resource according to various embodiments.

FIG. 13 is a flow diagram of a method for enforcing a time boundary for an access policy according to various embodiments.

FIG. 14 is a flow diagram of a method for auditing resource access under dynamically generated access policies according to various embodiments.

FIG. 15 is a flow diagram of a method for updating a service for dynamic generation of access policies according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

To address the challenges associated with related art systems, there is a need for an intelligent, automated system capable of dynamically generating access policies in response to real-time user requests. Conventional solutions fail to provide fine-grained, task-specific access control without burdensome administrative overhead. Existing approaches also struggle to maintain security and efficiency across multiple cloud platforms, as each provider has distinct policy structures, requiring administrators to manually craft policies for each environment. Additionally, traditional access management techniques do not effectively incorporate contextual information to refine and optimize access policies, often resulting in overly permissive or insufficient access grants.

Various embodiments implement advancements in artificial intelligence, particularly in the domain of large language models (LLMs) and retrieval-augmented generation (RAGS) frameworks to enhance access control mechanisms. By leveraging AI-driven techniques, various embodiments, dynamically generate access policies based on user intent, contextual information, and real-time system states. The system integrates AI with access management to determine the specific resources required by a user, automatically generate a tailored access policy, and enforce just-in-time, time-bound access restrictions. This ensures that users receive only the necessary permissions for their tasks while preventing excessive privilege accumulation.

A further challenge in access management is maintaining an up-to-date representation of the cloud infrastructure and associated resources. As services and infrastructure evolve, organizations must continuously update access policies to reflect these changes. Various embodiments provide a system that utilizes knowledge repository (e.g., structured inventory data) to maintain an inventory of resources. The use of this maintenance of an inventory of resources and/or IAM roles can enhance the accuracy and efficiency of policy generation. In some embodiments, if infrastructure inventory data is unstructured, the system uses embedding models to characterize and retrieve relevant contextual data, enabling the AI system to generate highly precise and adaptive access policies.

By introducing an AI-driven approach to access policy generation, organizations can reduce administrative complexity, improve security posture, and enhance compliance with regulatory requirements. Automating the process of determining, generating, and enforcing access policies based on real-time contextual insights enables organizations to operate more efficiently while minimizing security risks associated with static or outdated access configurations.

Various embodiments provide systems and methods for dynamically generating access policies for network resources. According to various embodiments, the system is an AI-driven system that receives user access requests and generates just-in-time, time-bound access policies. Traditionally, access to cloud services and other network resources has been managed through static configurations and predefined policies, which can be inflexible in environments with rapidly changing infrastructures or multiple cloud providers. Various embodiments address these limitations by leveraging advanced AI, such as LLMs, to dynamically determine a user's intent and generate tailored access policies based on real-time contextual data. By incorporating AI into the process, the system streamlines access management, minimizes administrative overhead, and enhances security by granting the least privilege necessary for a given task.

Various embodiments provide a method, system, and/or computer system for dynamically generating and management permissions for multi-cloud service and/or infrastructure resources. The method includes: (i) determining, using an AI-powered dynamic decision-making model, access decisions for user authorization for each of a plurality of cloud providers for an enterprise, and (ii) automatically provisioning access to a user based on the determined access decisions for user authorization for each of the plurality of cloud providers.

Various embodiments provide a method, system, and/or computer system for dynamically generating and management permissions for multi-cloud service and/or infrastructure resources. The method includes: (i) receiving a request from a user for access to one or more network resources, (ii) generating, based on the request, in real time a policy to allow the user to access the one or more resources, and (iii) providing access to the one or more resources in accordance with the policy.

In some embodiments, a user submits a request through an interface to access a particular service or infrastructure resource. The system processes this request by utilizing an AI backend that performs a retrieve, augment, and generate (RAGS) process. Initially, the system (e.g., the AI backend) determines the specific intent behind the request and identifies the precise resources or parameters required. For example, the system queries an LLM to analyze the access request and determine the intent. The system then augments the AI's (e.g., the LLM's) context by retrieving session-specific data from a vector database or other data stores, where detailed information about the multi-cloud inventory is maintained. In some embodiments, if infrastructure inventory data is unstructured, embedding models are implemented to generate vector representations of the contextual data, which are updated dynamically to reflect changes in the environment. Based on the retrieved and augmented context, the AI dynamically generates an access policy that not only provides just-in-time access but also imposes a time-bound constraint, automatically revoking permissions after a predetermined period or upon task completion. This technique ensures that permissions remain relevant and reduces the risk of over-permissioning, thereby enhancing security and compliance.

According to various embodiments, the system operates through a structured workflow designed to ensure secure, efficient, and dynamic access management. The process begins when a user submits an access request, specifying the service or infrastructure resources they need to interact with. This access request is intercepted and processed by an AI backend, which may deploy a large language model (LLM) or similar AI-driven logic to analyze the access request. The AI backend determines the intent behind the access request, identifies the relevant services and infrastructure components, and assesses the necessary permissions required for the requested task. By leveraging service inventory data, the AI backend ensures that only the minimal set of permissions necessary to perform the task is included in the access policy.

In some embodiment, once the system (e.g., the AI backend) determines the required access permissions, the system (e.g., the LLM deployed by the AI backend) cross-references the user's existing access rights to avoid unnecessary privilege expansion. If the user already has some or all of the requested permissions, the system (e.g., the LLM deployed by the AI backend) ensures that redundant or excessive permissions are not granted. This adherence to the principle of least privilege minimizes security risks and prevents over-permissioning. Based on this analysis, the system (e.g., the AI/LLM deployed by the AI backend) dynamically generates the IAM rules or access policy tailored to the specific cloud environment where the requested resources are hosted. The policy is formatted (e.g., generated in a corresponding schema) according to the appropriate IAM model, whether for Amazon Web Services (AWS), Azure, Google Cloud (GCP), or other cloud platforms, ensuring seamless enforcement within the designated infrastructure.

Once the access policy is generated, the system can use an access manager service to store the policy along with relevant metadata, such as session ID, user identity, resource details, and expiration parameters. If the request falls into a high-risk category or requires administrative oversight, the access manager triggers an approval workflow, notifying project owners, administrators, or security teams. These stakeholders can then review the request and grant or deny access based on established security protocols. For lower-risk requests or those that align with predefined user privileges, the system may automatically approve access, streamlining the process while maintaining security controls.

For approved access grants, whether through automatic validation or manual approval, the system proceeds to enforce the generated IAM rules. The system uses the access manager service to apply the permissions to the user's session, ensuring that the user has the appropriate level of access to the requested resources. In some embodiments, this enforcement occurs directly within the cloud IAM systems, integrating with AWS IAM, Azure AD, Google Cloud IAM, or other identity management frameworks to ensure that access is properly provisioned. The system also ensures that access is granted only for the duration specified in the policy, further reducing security risks associated with long-lived permissions.

According to various embodiments, as the session progresses, the system continuously monitors access expiration and compliance. The access manager tracks the session duration and ensures that permissions are revoked when (e.g., at the earliest of) the task is complete or when the time-to-live (TTL) on the policy expires. If the user requires additional time, the system can trigger a renewal process, prompting the user to request an extension or notifying an administrator for review. If no extension is granted, the system automatically revokes access by deleting the policy or modifying it to remove privileges, preventing stale permissions from lingering beyond their intended use.

In some embodiments, the system implements auditing and feedback to improve future access management. The system logs every action within the access lifecycle (e.g., request submission, policy generation, approval decisions, access grants, revocations, and modifications, etc.) in a centralized audit repository (e.g., a log database). These logs provide valuable data for compliance verification, security monitoring, and forensic investigations. Additionally, the system uses this audit data to refine its AI-driven policy generation. By analyzing historical access patterns, approval trends, and policy modifications, the system (e.g., the AI backend or specifically the LLM deployed at the AI backend) continuously improves its ability to generate more accurate and compliant access policies, reducing manual interventions and ensuring that future access requests are processed with greater precision.

By integrating AI-driven decision-making, automated enforcement, and continuous learning, the system provides a comprehensive and adaptive solution for managing user access across cloud environments. Various embodiments ensure that access is granted securely, efficiently, and in alignment with organizational policies while maintaining strong oversight through expiration management, auditing, and AI-driven optimizations.

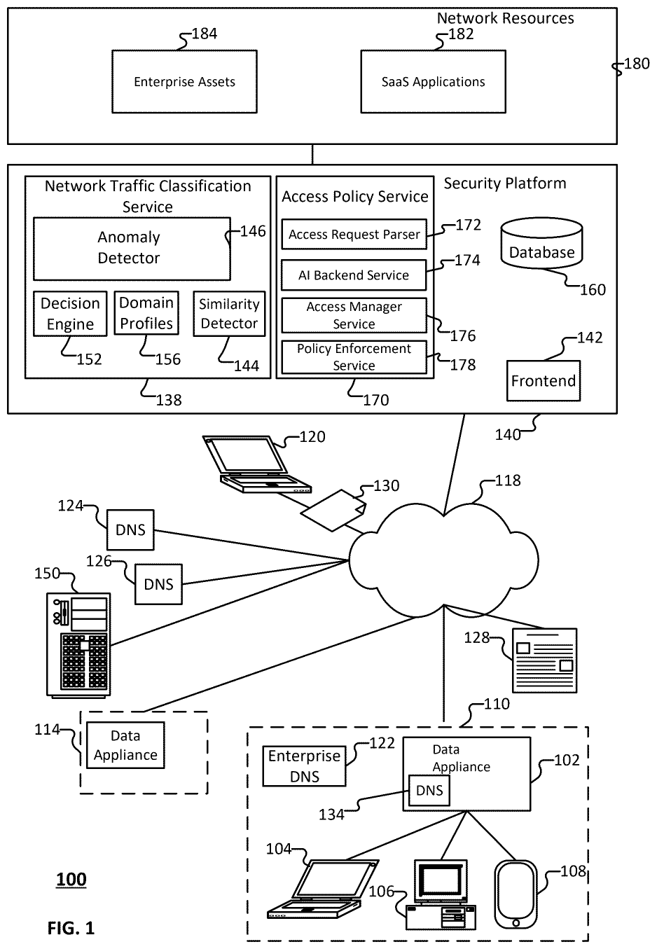

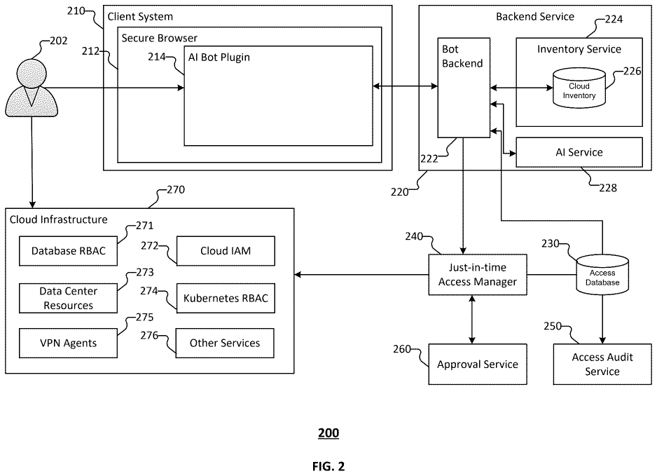

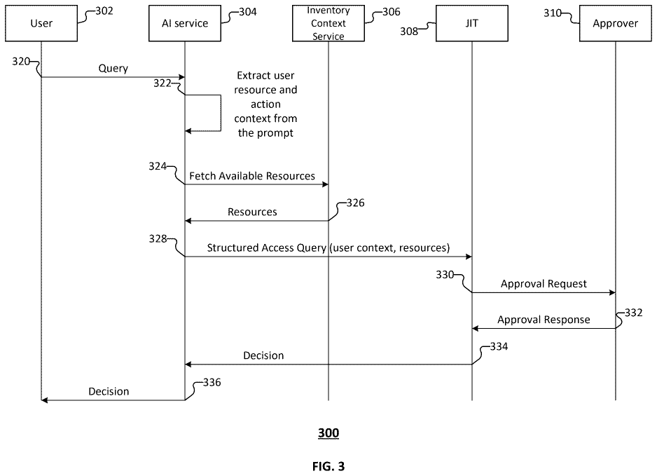

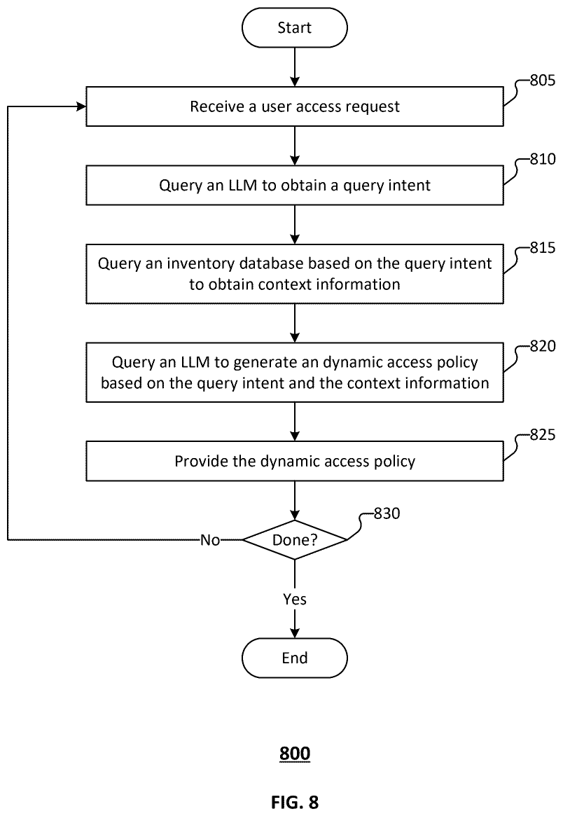

FIG. 1 is a block diagram of an environment for managing permissions to resources in an enterprise network according to various embodiments. According to various embodiments, system 100 implements an AI-driven access management platform/service that dynamically generates just-in-time, time-bound access policies for network resources, including cloud-based services and infrastructure. In some embodiments, system 100 is implemented at least in part by system 200 of FIG. 2. In some embodiments, system 100 implements at least part of processes 300-600 of FIGS. 3-6, and/or processes 800-1500 of FIGS. 8-15.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively blocking or sinkholing traffic, such as traffic to malicious domains, DNS hijacked domains, stockpiled domains, or squatting domains, or such as traffic for certain applications (e.g., SaaS applications). In some embodiments, data appliance 102 is also configured to enforce policies with respect to traffic that stays within (or from coming into) enterprise network 110.

System 100 comprises a security platform 140 that can provide security services for network resources 180 (e.g., a cloud infrastructure), such as software-as-a-service (SaaS) applications 182 and/or enterprise assets 184. For example, security platform 140 can perform authentication services for authentication of endpoints, such as client devices 104-108, in connection with providing access to network resources 180. As another example, security platform 140 can manage access policies, including dynamically provisioning access policies for ad hoc user access requests.

Techniques described herein can be used in conjunction with a variety of platforms (e.g., desktops, mobile devices, gaming platforms, embedded systems, etc.) and/or a variety of types of applications (e.g., Android .ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 (e.g., a security entity) can be configured to work in cooperation with remote security platform 140. Security platform 140 can provide a variety of services, including authenticating endpoints, provisioning access policies for accessing network resources 180, providing secure access to network resources 180, auditing use of provisioned access policies, auditing access events to network resources 180, resolving DNS queries, providing DNS resolving security services, classifying domains (e.g., predicting whether a domain is a malicious domain, etc.), classifying DNS response records (e.g., predicting whether a domain IP pair in a DNS response is a DNS hijacked record, etc.), classifying network traffic, classifying DNS traffic, providing a mapping of signatures to certain domains or DNS records, performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, detecting squatting domains, detecting a DNS cache poisoning attack (e.g., an attempt or a DNS cache entry stored based on an effective DNS cache poisoning attack), providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that DNS traffic (e.g., a domain or DNS record comprised in the DNS traffic) is malicious or benign, providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), etc.

In some embodiments, network security services, such as authentication services, are implemented at data appliance 102. As an example, data appliance 102 can authenticate endpoints for access to network resources 180. The authentication services may include performing IKEv2 authentication for the endpoints.

In some embodiments, network security services are implemented by one or more servers, such as a cloud service. Examples of the network security services include one or more of: (a) receiving an access request (e.g., for accessing resources within the cloud infrastructure, such as network resources 180), (b) parsing the access request, (c) determining the query intent for the access request (e.g., by querying an LLM or other AI-assisted service to analyze the access request), (d) collecting contextual data for the access request (e.g., based on the query intent), (e) querying an inventory database storing information of resources in the cloud infrastructure for contextual data pertaining to resources/services within the cloud infrastructure, (f) querying an access database storing information of access permissions for cloud infrastructure resources (e.g., to determine a user's current set of permissions), (g) dynamically generating an access policy (e.g., based on the query intent and the collected contextual data), (h) querying an LLM or other ML model or AI service to generate an access policy for an access request received from a user, (i) applying an approval mechanism to a dynamically generated access policy (e.g., determine whether the access policy is pre-approved/automatically approved, prompt an administrator or resource manager/owner to manually approve an access policy, etc.), (j) enforcing a time-bound on the access policy (e.g., enforcing an expiration for the dynamically generated access point), (k) providing access to network resources 180 (e.g., in accordance with the dynamically generated access policy), etc.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises/implements network traffic classification service 138 and/or access policy service 170. Security platform 140 may include various other services/modules, such as a malicious file detector, a malicious traffic detector, a parked domain detector, an application classifier or other traffic classifier, etc.

Network traffic classification service 138 is used in connection with analyzing network traffic (e.g., websites, domains, sample files, etc. pertaining to the network traffic) and/or automatically detecting malicious network traffic. For example, network traffic classification service may include anomaly detector 145, decision engine 152, domain profiles 156, and/or similarity detector 144.

Access policy service 170 is used in connection with dynamically generating access policies for a network and network resources 180. For example, access policy service 170 generates real-time/on-demand access policies in response to ad hoc user access requests. Access policy service 170 can analyze (e.g., using an LLM or other AI service) a received access request and determine a query intent. Access policy service 170 can supplement the query intent with contextual data by collecting this contextual data based on the query intent, such as by querying an inventory database for resource contextual data and/or querying an access database for access/permission contextual data. Access policy service 170 dynamically generates the access policy based on the query intent and/or the contextual data. For example, access policy service 170 queries an LLM to generate the access policy. Access policy service 170 can then enforce the dynamically generated access policy.

In some embodiments, access policy service 170 comprises one or more of access request parser 172, AI backend service 174, access manager service 176, and/or policy enforcement service 178.

Access policy service 170 uses access request parser 172 to receive an access request from a user and to parse the access request to determine a query intent. In some embodiments, in connection with parsing the access request to determine the query intent, access request parser 172 queries an LLM to analyze the access request to obtain the query intent. For example, access request parser 172 invokes AI backend service 174 to analyze the access request.

Access policy service 170 uses AI backend service 174 to analyze an access request and generate a dynamically generated access policy for the access request. AI backend service 174 can query an LLM or other AI service to analyze the access request in connection with determining a query intent. In response to obtaining the query intent, AI backend service 174 can query one or more knowledge base datasets for contextual data. For example, AI backend service 174 can query an inventory database (e.g., comprised in database 160) for resource contextual data. As another example, AI backend service 174 can query an access database (e.g., comprised in database 160) for access/permission contextual data. In some embodiments, AI backend service 174 uses an LLM to generate the queries to query the one or more knowledge base datasets for contextual data. AI backend service 174 can prompt the LLM to generate the queries based at least in part on the query intent. In response to receiving the contextual data, AI backend service 174 queries the LLM or other AI service to generate the dynamically generated access policy for the access request. For example, AI backend service 174 prompts the LLM to generate the dynamically generated access policy based on the query intent and the contextual data.

Access policy service 170 uses access manager service 176 to store the dynamically generated access policy. In addition, access manager service 176 can be used to implement an approval mechanism to determine whether the dynamically generated access policy is approved. For example, access manager service 176 can implement a pre-approval mechanism, such as by analyzing the access policy against a set of predefined rules or heuristics to determine whether the dynamically generated access policy satisfies pre-approval criteria. Additionally, or alternatively, access manager service 176 can invoke a manual approval process (e.g., in response to determining that the dynamically generated access policy does not satisfy the pre-approval criteria) to obtain approval from an approver (e.g., an administrator, a resource owner/manager, etc.). Access manager service 176 can prompt the approver to approve/deny the access policy for the access request.

In some embodiments, access manager service 176 enforces a time-bounding of a dynamically generated access policy, such as by enforcing an expiration date or TTL associated with the dynamically generated access policy.

In some embodiments, access manager service 176 is used to perform an auditing of the access policies, such as to audit access events performed under a dynamically generated access policy or to analyze the precision of the access policy (e.g., to determine whether the expiration/TTL for the access policy was appropriately set, whether the scope of the access policy was sufficient such as based on whether the user had to request additional permissions, etc.).

Access policy service 170 uses policy enforcement service 178 to enforce the access policy with respect to user attempts to access the network resources 180 (e.g., SaaS application 182, enterprise assets 184, etc.).

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, or whether a DNS record is malicious), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, a website content, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process.

The classifier(s) may implement one or more machine learning models that may be trained according to a machine learning process. Examples of machine learning processes that can be implemented include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic (e.g., that the domain associated with the network traffic is a squatting domain), system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample, or a domain associated with the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains (e.g., domains classified as squatting domains) or having certain characteristics/profiles is to be blocked and network traffic associated with other domains (e.g., domains not deemed to be squatting domains or otherwise malicious) or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed domain for a particular network traffic sample, such as a DNS request or DNS response), security platform 140 (e.g., network traffic classification service 138) sends an indication that network activity (e.g., other network traffic samples) associated with the domain are associated with, or otherwise correspond to, the determined classification. Security platform 140 can provide an indication that network traffic matching the network traffic sample predicted to be malicious (e.g., network traffic matching a domain predicted to be a squatting domain) is to be handled as a malicious network traffic. For example, security platform 140 determines (e.g., computes) a signature or identifier for the network traffic/activity (e.g., a hash or other signature, or identifier for the corresponding network session or domain), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable. In some embodiments, access policy service 170 is implemented at enterprise DNS server 122 rather than, or in addition to, being implemented at security platform 140.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite. com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

According to various embodiments, a security entity and/or network node (e.g., a client, device, etc.) handles a file based at least in part on an indication that the file is malicious and/or that the file matches a file indicated to be malicious. In response to receiving indication that the file (e.g., the sample is malicious), the security network and/or network node may update a mapping of files to an indication of whether the corresponding file is malicious, and/or a blacklist of files. In some embodiments, the security entity and/or the network node receives a signature pertaining to a file (e.g., a sample deemed to be malicious), and the security entity and/or the network node stores the signature of the file for use in connection with detecting whether files obtained, such as via network traffic, are malicious (e.g., based at least in part on comparing a signature generated for the file with a signature for a file comprised in a blacklist of files). As an example, the signature may be a hash.

Security entities (e.g., firewalls) typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies.

Security devices (e.g., security appliances, security gateways, security services, and/or other security devices) can include various security functions (e.g., firewall, anti-malware, intrusion prevention/detection, Data Loss Prevention (DLP), and/or other security functions), networking functions (e.g., routing, Quality of Service (QoS), workload balancing of network related resources, and/or other networking functions), and/or other functions. For example, routing functions can be based on source information (e.g., IP address and port), destination information (e.g., IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform state-based packet inspection in which each packet is examined within the context of a series of packets associated with that network transmission's flow of packets. This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content (e.g., next generation firewalls). In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls). For example, Palo Alto Networks' next generation firewalls enable enterprises to identify and control applications, users, and content-not just ports, IP addresses, and packets-using various identification technologies, such as the following: APP-ID for accurate application identification, User-ID for user identification (e.g., by user or user group), and Content-ID for real-time content scanning (e.g., controlling web surfing and limiting data and file transfers). These identification technologies allow enterprises to securely enable application usage using business-relevant concepts, instead of following the traditional approach offered by traditional port-blocking firewalls. Also, special purpose hardware for next generation firewalls (implemented, for example, as dedicated appliances) generally provide higher performance levels for application inspection than software executed on general purpose hardware (e.g., such as security appliances provided by Palo Alto Networks, Inc., which use dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' VM Series firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

FIG. 2 is a block diagram of an environment for managing permissions to resources in an enterprise network according to various embodiments. According to various embodiments, system 200 is an AI-driven access management platform/service that dynamically generates just-in-time, time-bound access policies for network resources, including cloud-based services and infrastructure. In some embodiments, system 200 is implemented at least in part by system 100 of FIG. 1. In some embodiments, system 200 implements at least part of processes 300-600 of FIGS. 3-6, and/or processes 800-1500 of FIGS. 8-15.

As shown, system 200 comprises backend service 220 (e.g., a dynamic access policy generation service). System 200 may additionally include one or more of client system 210, access database 230 (e.g., a database of user permissions or access grants, etc.), just-in-time-access (JIT) manager 240, access audit service 250, approval service 260, and cloud infrastructure 270, etc.

In modern, multi-cloud environments, managing access control is increasingly complex due to the need for granular, context-specific permissions across diverse cloud platforms. Traditional Role-Based Access Control (RBAC) systems typically grant users broad access to resources based on roles, which often leads to over-permissioning, security risks, and challenges in ensuring least privilege. This becomes even more problematic in production environments, where elevated access may remain active for prolonged periods of time.

One critical challenge in implementing efficient access control is the lack of service-specific knowledge about the permissions required for specific tasks. For example, when debugging a service issue, users may not know exactly which resources they need access to (e.g., logs, configuration files, databases, or specific VMs), and security teams may struggle to determine and grant the appropriate permissions. Without a comprehensive service inventory, defining and restricting access only to the required resources for a given task is difficult, leading to potential security vulnerabilities.

Key challenges in generating access policies in real time include:
Over-Permissioning and Least Privilege Violation: Users often request access to more resources than they need, and permission revocation is not always timely. This creates unnecessary security risks, especially when users are granted broad access to production environments.
Lack of Service-Specific Inventory Knowledge: Without a detailed inventory of services and associated resources, it is difficult to determine the exact set of permissions a user needs to perform a specific task, such as debugging or monitoring a service. For example, a user might need access to logs, metrics, or a specific virtual machine (VM) to troubleshoot a performance issue, but without knowledge of the service's architecture and dependencies, precisely identifying which permissions are required is extremely difficult. As a result, users may be granted access to more resources than necessary, thereby violating the principle of least privilege.
Complex Multi-Cloud Environments: Organizations often work across multiple cloud providers (e.g., AWS, Azure, GCP, etc.), each with their own IAM model and RBAC policies. Managing access across these clouds is complex and requires deep integration with each platform's IAM system, making it difficult for security teams to provide precise access controls that adhere to each cloud's specific security policies.
Time-Bound Access With Approval Workflows: to improve network security, access permissions should be granted for a specific duration to ensure that elevated permissions are only available as long as the task requires. Traditional RBAC systems lack the ability to enforce time-based access or provide approval workflows that are tailored to the specific resource or task a user needs to perform.
Audit and Compliance Gaps: Without clear, context-specific logs of user access, ensuring compliance and tracking which permissions were granted, for what purpose, and whether they were revoked after completion is difficult. This lack of detailed audit trails hinders the ability to enforce security policies and review user behavior effectively.

User 202 uses a client system 210 to submit an access request for access to one or more resources in cloud infrastructure 270, etc. For example, User 202 submits the access request to an AI bot plugin 214 (or other interface) presented on a user interface displayed by the client system 210, such as via a secure browser 212. According to various embodiments, when (e.g., in response to) a user 202 submits an access request for access to resources, system 200 (e.g., backend service 220) processes the access request using an artificial intelligence model (e.g., AI service 228), such as an LLM, to determine the user's intent and the specific resources required/requested. System 200 (e.g., backend service 220) then retrieves relevant contextual data from a knowledge base, which may include a multi-cloud inventory, etc. This contextual data may be used to augment the generation (e.g., by the LLM) of an access policy for the access request. As an example, the contextual data may be stored in an inventory database (e.g., cloud inventory database 226). In some embodiments, the contextual data is continuously or periodically updated to reflect changes in the services and/or infrastructure or security policies associated therewith. In other embodiments, the contextual data is updated in response to detecting a change in the services or infrastructure, or a security policy.

System 200 comprises a bot backend service 222, an inventory service 224, and an AI service 228. System 200 uses bot backend service 222 to receive input from the user via secure browser 212 (e.g., AI bot plugin 214) and to orchestrate the processing of the access request to generate a dynamically generated access policy. In response to receiving the access request, bot backend service 222 queries AI service 228 (e.g., an LLM at AI service 228) to process/interpret the access request to determine a query intent (e.g., to identify the parameters of the access request, such as the resources being requested, etc.). Bot backend service 222 then queries inventory service 224 for contextual data, for example, resource contextual data. In some embodiments, bot backend service 222 requests AI service 228 (e.g., an LLM) to generate a query prompt for use to query inventory service 224. Bot backend service 222 can additionally obtain contextual data from access database 230. Access database 230 may store user permissions, etc. In response to receiving the contextual data, bot backend service 222 queries AI service 228 to generate a dynamically generated access policy for the access request, for example, based on the query intent and the contextual data.

In response to obtaining (e.g., generating) the dynamically generated access policy, backend service 220 (e.g., bot backend service 222) provides the access policy to JIT manager 240. JIT manager 240 can store the access policy, for example, in access database 230. In some embodiments, JIT manager 240 enforces an approval mechanism. According to this approval mechanism, in response to receiving the access policy, JIT manager 240 determines whether the access policy grant is approved. For example, JIT manager 240 requests approval service 260 to implement the approval mechanism with respect to the dynamically generated access policy. JIT manager 240 (e.g., approval service 260) can use pre-defined approval criteria (e.g., a set of rules or heuristics) to determine whether the access policy is automatically approved. Additionally, or alternatively, JIT manager 240 (e.g., approval service) can send the access policy for approval by an approver (e.g., an administrator, a resource owner/manager, etc.) to approve/deny the access policy for the access request. In response to determining that the access policy is approved, the access policy is provided to cloud infrastructure 270 in connection with user 202 attempting to connect to and access resources within cloud infrastructure 270. Examples of resources that may be comprised in cloud infrastructure 270 include database RBAC 271, cloud IAM 272, data center resources 273, Kubernetes RBAC 274 (or a RBAC for clusters), VPN agents 275, and/or other service 276.

In some embodiments, the system (e.g., backend service 220) augments the AI model's context (e.g., the context of the LLM deployed at the AI service 228) with session-specific information before generating an access policy. For example, the system (e.g., backend service 220) augments the context based at least in part on implementing an RAGS framework. The access policy is dynamically generated (e.g., by backend service 220) to grant the minimum necessary permissions required for the requested task and/or is configured with a time-to-live (TTL) or expiration, ensuring that access is automatically revoked once the task is complete or the session ends. This technique enhances security by preventing excessive or stale permissions while also streamlining access management across multiple cloud providers.

The generation of dynamically generated access policies by system 200 (e.g., backend service 220) eliminates (or otherwise reduces) the need for manual policy creation, reducing administrative overhead and improving operational efficiency. By leveraging AI-driven automation, system 200 enables organizations to maintain strong security controls, enforce the principle of least privilege, and comply with regulatory or compliance requirements while providing users with seamless access to the resources they need.

According to various embodiments, when a user submits an access request to access a network resource, system 200 first determines whether the request originates from a legitimate user and is not associated with malicious activity. For example, the validation/authentication of the user through an enforcement point (not shown) that intercepts the access request before it reaches the backend service 220 responsible for policy generation. The enforcement point may reside between client system 210 and backend service 220. The enforcement point may additionally reside between client system 210 and cloud infrastructure 270. In some embodiments, the enforcement point serves as a security gateway that analyzes the request to validate the user's identity and assess potential security threats. Authentication and validation may be performed using multiple factors, such as credentials, biometric authentication, or security tokens, along with contextual signals like device information, geolocation, and behavioral patterns, etc.

As part of the validation process, the enforcement point can cross-reference the access request with known authentication databases, identity providers, and threat intelligence sources. If any anomalies are detected, such as an unusual access pattern or an authentication attempt from a suspicious location, the system may require additional verification or block the request entirely. The enforcement point may also use AI-driven behavioral analysis to detect deviations from a user's typical activity, helping to identify potentially compromised accounts or insider threats.

Upon successful validation and authentication, the enforcement point passes the access request to the backend service 220 for further processing. The backend service 220 then interprets the access request and determines the appropriate access permissions by analyzing the user's role, intent, and the specific resources being requested. This process involves leveraging an AI model, such as a large language model, to understand the access requirements and retrieve relevant context from a knowledge base or vector database. By ensuring that only authenticated and trusted users proceed to the policy generation stage, system 200 enhances security and prevents unauthorized access attempts.

In some embodiments, to generate precise and secure access policies dynamically, the system (e.g., backend service 220) implements a RAGS process to enhance the LLM's context with relevant data. When a user 202 submits an access request, the system (e.g., backend service 220) retrieves necessary contextual information that helps the AI backend (e.g., the LLM deployed at the AI backend) determine the appropriate permissions. This retrieval process ensures that policy generation is not only driven by the user's access request but is also informed by current or real-time data about the requested resources, existing RBAC policies, and security constraints specific to the environment.

During the retrieval phase, the system (e.g., backend service 220) gathers information necessary to process the access request effectively. This includes identifying the relevant service components, associated resources, and existing access controls for the requested service/resources. For example, if a user requests debugging access to a virtual machine (VM), the system (e.g., backend service 220) retrieves metadata about the relevant service, including the involved VMs, logs, monitoring data, and other associated resources that may be needed for debugging. Additionally, the system (e.g., backend service 220, or more specifically, inventory service 224) retrieves cloud-specific RBAC models, to ensure that the dynamically generated policy aligns with the roles and permissions already defined within the cloud environment. This retrieval process ensures that access policies are generated with a more complete understanding of both the technical infrastructure and the security framework governing the requested resources.

In some embodiments, once the necessary data is retrieved, the system (e.g., backend service 220) augments the LLM's context with additional session-specific and security-related information. In some embodiments, the system (e.g., backend service 220) uses the AI (e.g., the LLM deployed at the AI service 228) to assess the user's current session and existing permissions to ensure that it does not over-provision access, thereby adhering to the principle of least privilege. By cross-referencing the user's 202 current roles and the requested permissions, the system (e.g., backend service 220) determines whether an escalation is necessary and, if so, grants only the minimal required privileges for the task. In some embodiments, to further refine access control, the system (e.g., backend service 220) may validate the legitimacy of the task by querying an external task management system that confirms whether the user has been assigned to perform the requested action. Additionally, the system (e.g., backend service 220) incorporates security augmentation measures, such as enforcing time-bound access policies or applying conditional restrictions like read-only access. For example, if a user requests debugging access, the system ensures that access is granted only for the required resources and for the necessary duration, preventing over-permissioning and mitigating security risks.

After retrieval and augmentation, the AI (e.g., the LLM deployed at the AI backend) generates an access policy (e.g., a cloud-specific IAM policy) that is specifically tailored to the user's access request. The generated policy precisely specifies the permissions needed for interacting with the requested resources, such as reading logs, restarting a VM, or modifying configurations. The system (e.g., the LLM deployed at the AI service 228) ensures that these policies are both cloud-specific and task-specific by dynamically constructing the appropriate IAM policy schemas that match the requirements of the underlying cloud environment. This means that if the requested access pertains to AWS, the system generates an AWS IAM policy, while for an Azure-based request, the system generates an Azure role assignment, and so forth. The AI-driven policy generation process enables seamless and secure access management while maintaining compliance with organizational security policies.

FIG. 3 is a sequence diagram of a method for dynamically provisioning access to network resources according to various embodiments. In some embodiments, process 300 is implemented at least in part by system 100 of FIG. 1 and/or system 200 of FIG. 2. A system for generating a dynamic access policy may comprise client system 302, an AI service 304, an inventory context service 306, a just-in-time (JIT) service 308, and approver system 310.

At 320, a user uses client system 302 to submit a query, for example, an access request. In response to receiving the query (e.g., the access request), the system can forward the query to AI service 304. AI service 304 may comprise an LLM that is used to analyze the access request, such as to determine a query intent, to obtain contextual data, and to generate a dynamically generated access policy. At 322, the AI service 304 extracts information from the access request, such as in connection with determining a query intent. For example, the AI service 304 extracts user, resource, and action context data from the access request. At 324, the system fetches available resource information from inventory context service 306. For example, in response to extracting the query intent from the access request, the AI service 304 can query an inventory database (e.g., inventory context service 306) and/or an access database (e.g., a database storing permissioning information). At 326, inventory context service 306 provides resource information to AI service 304. The AI service 304 generates a structured access query to request a cloud-specific access policy. For example, the AI service 304 queries an LLM to generate an access policy based at least in part on the query intent and the contextual data (e.g., the data pertaining to an inventory context, a user/permission context, etc.). At 328, the AI service 304 provides the access policy (e.g., a structured access policy) to the JIT service 308. JIT service can send a request to approver system 310 for an approver (e.g., an administrator, a resource owner/manager, etc.) to approve/deny the access policy for the access request. At 332, approver system 310 provides the approval response to JIT service 308. At 334, JIT service 308 provides AI service 304 with an indication of the approval response (e.g., an indication of whether the access policy was approved or denied). At 336, AI service 304 returns the approval response to the user via client system 302.

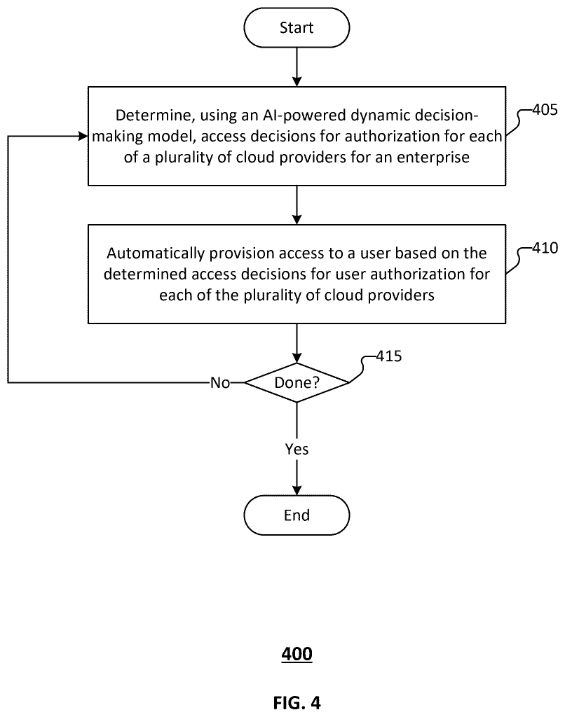

FIG. 4 is a flow diagram of a method for determining the access specific to a cloud provider and provisioning the access according to various embodiments. In some embodiments, process 400 is implemented at least in part by system 100 of FIG. 1 and/or system 200 of FIG. 2.

At 405, the system determines an AI-powered dynamic decision-making model, access decisions for authorization for each of a plurality of cloud providers for an enterprise. At 410, the system automatically provisions access to a user based on the determined access decisions for user authorization for each of the plurality of cloud providers. At 415, the system determines whether process 400 is complete. In some embodiments, process 400 is determined to be complete in response to a determination that no further access policies are to be dynamically generated, no further resource access requests are received, no further resources are to be accessed, an administrator indicates that process 400 is to be paused or stopped, etc. In response to a determination that process 400 is complete, process 400 ends. In response to a determination that process 400 is not complete, process 400 returns to 405.

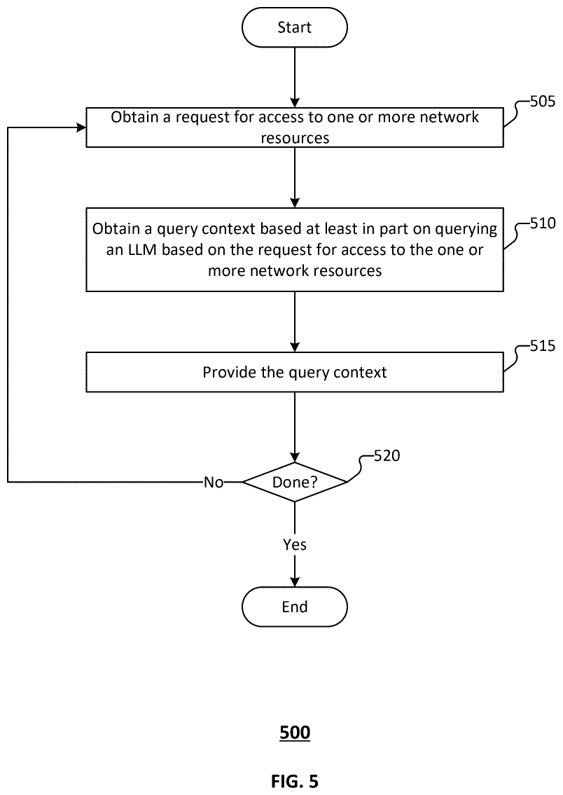

FIG. 5 is a flow diagram of a method for determining a query context according to various embodiments. In some embodiments, process 500 is implemented at least in part by system 100 of FIG. 1 and/or system 200 of FIG. 2.

At 505, the system obtains a request for access to one or more network resources. At 510, the system obtains a query context based at least in part on querying an LLM based on the request for access to the one or more network resources. At 515, the system provides the query context. At 520, the system determines whether process 500 is complete. In some embodiments, process 500 is determined to be complete in response to a determination that no further access policies are to be dynamically generated, no further resource access requests are received, no further resources are to be accessed, an administrator indicates that process 500 is to be paused or stopped, etc. In response to a determination that process 500 is complete, process 500 ends. In response to a determination that process 500 is not complete, process 500 returns to 505.

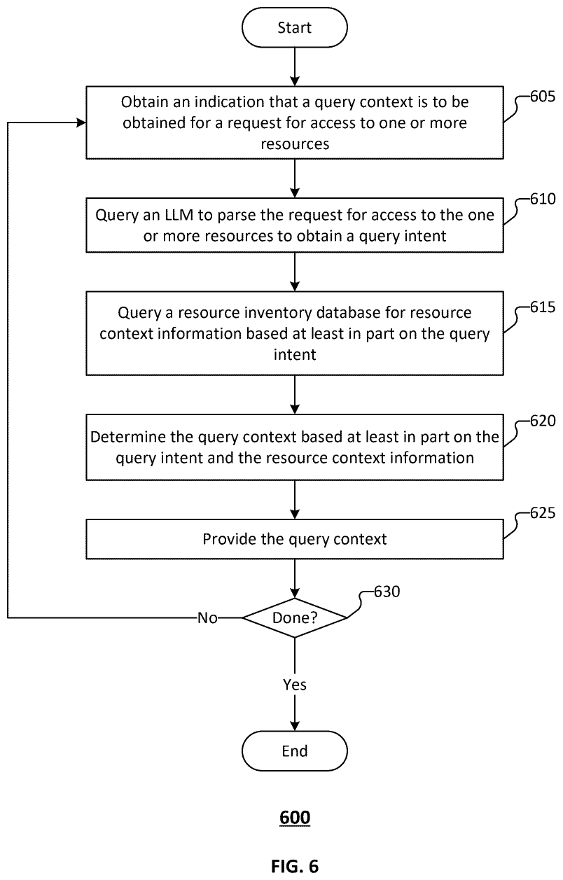

FIG. 6 is a flow diagram of a method for determining a query context according to various embodiments. In some embodiments, process 600 is implemented at least in part by system 100 of FIG. 1 and/or system 200 of FIG. 2.

At 605, the system obtains an indication that a query context is to be obtained for a request for access to one or more resources. At 610, the system queries an LLM to parse the request for access to the one or more resources to obtain a query intent. At 615, the system queries a resource inventory database for resource context information based at least in part on the query intent. At 620, the system determines the query context based at least in part on the query intent and the resource context information. At 625, the system provides the query context. At 630, the system determines whether process 600 is complete. In some embodiments, process 600 is determined to be complete in response to a determination that no further access policies are to be dynamically generated, no further resource access requests are to be processed, no further resources are to be accessed, an administrator indicates that process 600 is to be paused or stopped, etc. In response to a determination that process 600 is complete, process 600 ends. In response to a determination that process 600 is not complete, process 600 returns to 605.

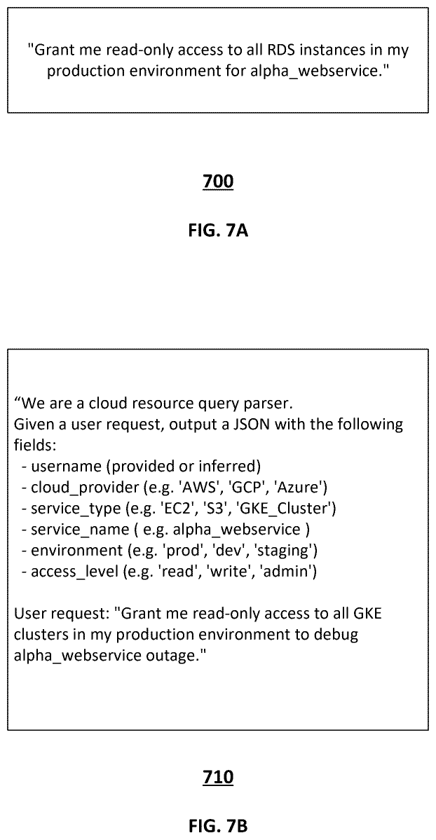

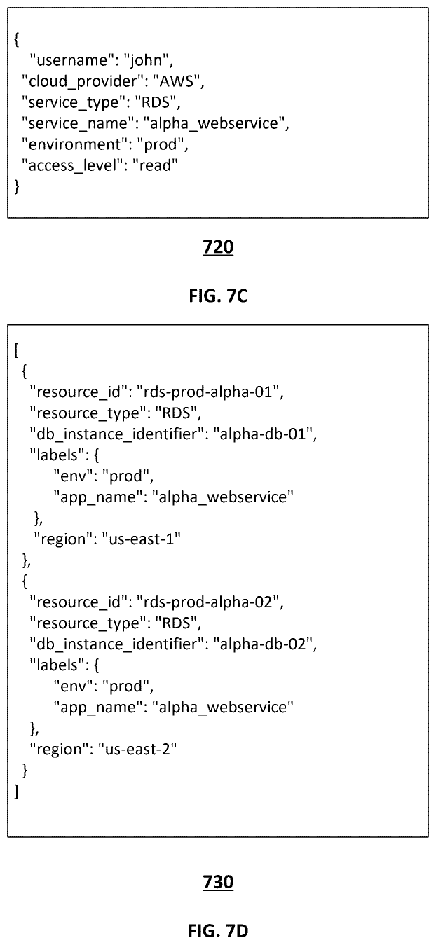

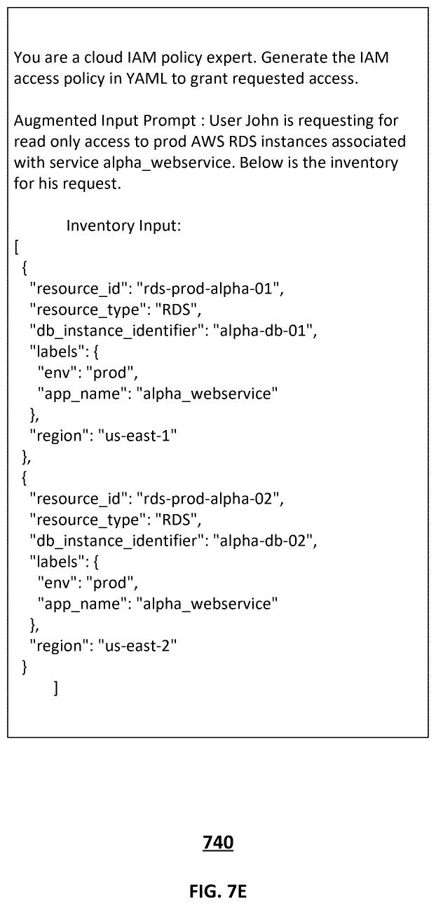

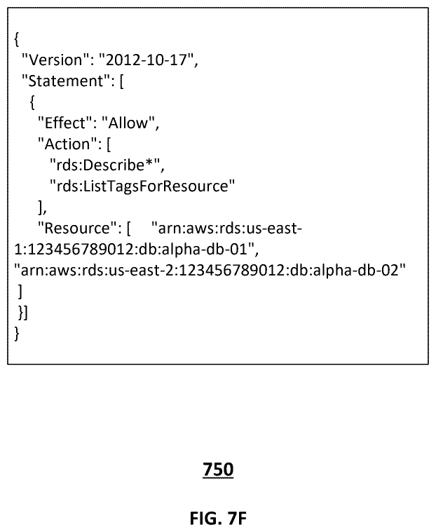

FIG. 7A is an example of a user access request according to various embodiments. In some embodiments, the system (e.g., the PA browser, AI backend service, etc.) receives a user access request 700 from a user. User access request 700 can be in natural language. Although user access request 700 in the example shown requests read-only access to all RDS instances in a production environment, various other user access requests can be input by the user. Another example of a user access request may be: “grant me read-only access to all GKE clusters in the production environment to debug alpha_webservice outage.

Once the user submits the access request, the system forwards the access request to the AI backend service, which is configured to interpret the access request and determine the appropriate access to be granted (if any) for the access request.

FIG. 7B is an example of a prompt used in connection with obtaining a query intent according to various embodiments. In some embodiments, the AI backend service will receive the input from the user (e.g., via a client system, such as a PA browser running on the client system) and uses the LLM to retrieve the data from the prompt. For example, the LLM is used to extract a query intent from the access request. The AI backend service will send requests to the LLM to obtain contextual data associated with the access request. For example, the AI backend service generates and sends a query/prompt such as prompt 710. As shown, prompt 710 comprises a first component corresponding to an instruction prompt (e.g., instructing the LLM of the data/action being requested) and a user prompt corresponding to the access request input by the user. The inclusion of the user prompt helps set the context for the LLM.

FIG. 7C is an example of structured data for the query intent according to various embodiments. In response to sending the query/prompt to the LLM, the AI backend service receives an LLM output corresponding to the query intent. For example, the AI backend service receives an LLM output such as query intent 720 from the LLM in connection with the example described above. In some embodiments, LLM output additionally includes other fields like project_id or region, depending on our prompt instructions and/or user context. The LLM output may additionally include a restatement of the access request. For example, the LLM output may include an augmented user prompt such as “User John is requesting for read only access to prod RDS instances associated with service alpha_webservice.”

In some embodiments, the system (e.g., the AI backend service) can implement a conversational loop. The conversational loop can be used to prompt the user for missing fields until a JSON object characterizing an access request is complete. For example, if the user did not specify enough details, the AI backend service can facilitate follow-up questions such as “which service do you want to grant access for?” or “which environment do you mean by ‘production’? Is it ‘prod’? ‘stage’? etc.”. The user provided inputs in response to these follow up questions are further analyzed, and the conversational loop can continually iterate/continue until the LLM can produce a complete JSON object that meets the schema requirements.

In some embodiments, the system uses the structured data in connection querying a knowledge base for contextual data. For example, the system uses the structured data to query an inventory database and/or an access database. The system may generate a JavaScript Object Notation (JSON) object based at least in part on the query intent (e.g., the structured data).

In some embodiments, the inventory database can be queried based on expressing filters on known fields, for example, if the inventory database stores well-structured data. Otherwise, the system may implement embedding models to represent/characterize the information stored in the knowledge base, for example, a knowledge base comprising information for a multi-cloud inventory and cloud specific rule access information.

FIG. 7D is an example of structured data for the query of an inventory database based on the query intent according to various embodiments. In response to receiving the query intent, the system (e.g., the AI backend service) generates a query with which to query an inventory database (e.g., an inventory object database), such as a MongoDB for structured inventory data, or vector database comprising vectors representing/characterizing the resources for which information is stored in an infrastructure knowledge base. As an example, the system generates inventory contextual information 730. The inventory contextual information may be generated in JavaScript Object Notation (JSON).

In response to querying the inventory database, the system receives contextual data, such as in the form of structured data 730. In this example, the contextual data may include a list of all RDS instances that match the environment (prod), the application name (alpha_webservice).

In some embodiments, in addition to the querying of the inventory database based on the query intent, the system (e.g., the AI backend service) queries an access database. For example, the system may query the access database using the following JSON object: “{“Username”: “john”; “session_id”: “a1b342ud”}”. In response to querying the access database, the system can receive a response indicating current access permissions the user has in the current session. The current access permissions may either no access or some access information. For example, the system may receives the following structured data of the current access permissions: “role: roles/iam.viewer; user: john@company.com.”

If the user access request is “grant me read-only access to all GKE clusters in the production environment to debug alpha_webservice outage”, the contextual data may include a list of all GKE clusters that match the environment (prod), the application name (alpha_webservice), etc.

FIG. 7E is an example of a prompt in connection with obtaining a dynamically generated access policy according to various embodiments. In response to receiving the contextual data, the system prompts an LLM to generate a dynamically generated access policy. The system can generate a prompt based on the query intent and the contextual data. In the example shown, the system generates prompt 740 and provides prompt 740 to the LLM. In some embodiments, the prompt uses query intent 720 (e.g., a JSON object) instead of the natural language augmented input prompt.

FIG. 7F is an example of a dynamically generated access policy according to various embodiments. In response to prompting the LLM to generate the dynamically generated access policy (e.g., submitting prompt 740 to the LLM), the system receives a dynamically generated access policy, such as access policy 750.

In some embodiments, the access policy is then (a) shown/provided to the user or the security admin for sign-off/approval, (b) attached to the user or a role in AWS IAM, and (c) potentially time-bound or managed via a “Just In Time” policy manager.

FIG. 8 is a flow diagram of a method for generating an access policy according to various embodiments. In some embodiments, process 800 is implemented at least in part by system 100 of FIG. 1 and/or system 200 of FIG. 2.

At 805, the system receives a user access request. At 810, the system queries an LLM to obtain a query intent. At 815, the system queries an inventory database based on the query intent to obtain context information. At 820, the system queries an LLM to generate an dynamic access policy based on the query intent and the context information. At 825, the system provides the dynamic access policy. At 830, the system determines whether process 800 is complete. In some embodiments, process 800 is determined to be complete in response to a determination that no further access policies are to be dynamically generated, no further resource access requests are to be processed, no further resources are to be accessed, an administrator indicates that process 800 is to be paused or stopped, etc. In response to a determination that process 800 is complete, process 800 ends. In response to a determination that process 800 is not complete, process 800 returns to 805.

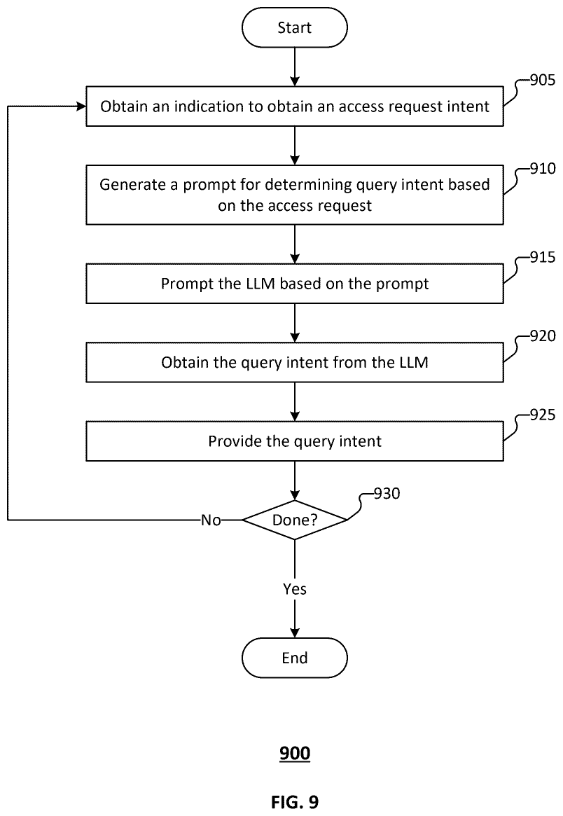

FIG. 9 is a flow diagram of a method for obtaining an access request intent according to various embodiments. In some embodiments, process 900 is implemented at least in part by system 100 of FIG. 1 and/or system 200 of FIG. 2.

According to various embodiments, the system employs an advanced AI-driven technique to determine the intent behind a user's access request, and ensure that permissions are granted in a precise and contextually appropriate manner. When a user submits a request for access, the system processes the request using an LLM capable of interpreting natural language inputs, structured requests, or API calls. The LLM analyzes the content of the access request to extract key information, including the type of resource being requested, the specific action the user intends to perform, and any contextual parameters associated with the access request. By understanding the underlying intent rather than relying on rigid, predefined rules, the system ensures that access decisions are flexible, intelligent, and aligned with the user's actual needs.

The access request may be input by the user as a natural language query, for example, to a prompt on a user interface. In response to receiving the access request, the LLM can apply a natural language processing in connection with determining the intent for the access request.

In some embodiments, to determine intent, the system first parses the request, breaking it down into distinct components such as the user's identity, the target resource, and the nature of the requested access. The LLM then applies natural language processing techniques to analyze the semantics of the request, identifying key phrases and contextual cues that indicate the purpose behind the access request. For example, if a user submits a request to “debug service X,” the system infers that the user likely requires access to associated logs, monitoring data, and relevant infrastructure components such as virtual machines or containers running the service. Instead of merely granting broad access to the entire system, the system (e.g., the LLM deployed at the AI backend) tailors the access scope to align precisely with the debugging task.

In some embodiments, the system further enhances intent determination by incorporating contextual information retrieved from a knowledge base. This knowledge base includes a comprehensive inventory of cloud services, infrastructure resources, and existing IAM role definitions, allowing the system (e.g., the LLM) to match the user's access request with the appropriate permissions. If an access request involves interacting with a cloud database, the LLM cross-references known dependencies, access policies, and prior access patterns to infer whether the user requires read-only access, query execution permissions, or administrative privileges. By leveraging structured and unstructured data stored within the knowledge base, the system (e.g., the LLM) ensures that access intent is understood in the context of the organization's security policies and operational needs.

To refine its interpretation of intent, the system can also evaluate the user's existing permissions and historical access patterns. If a user has previously requested similar access and received specific permissions, the system (e.g., the LLM) incorporates that knowledge into its decision-making process, reducing the need for redundant approvals while ensuring security compliance. Additionally, if the user's role, project, or team assignment has changed, the system considers these contextual shifts to ensure that access remains relevant to the user's current responsibilities. This feedback mechanism and adaptive learning capability prevents unnecessary privilege escalation while streamlining legitimate access requests.

By continuously analyzing user access requests, contextual data, and historical access behaviors, the system achieves a highly intelligent approach to intent determination. This AI-driven mechanism allows for dynamic, real-time interpretation of access requests, ensuring that permissions are granted with precision and security. The combination of natural language understanding, knowledge base integration, and contextual adaptation enables the system to provide an efficient and robust access management solution, aligning access control with both user needs and organizational security policies.

Returning to the example shown, at 905, the system obtains an indication to obtain an access request intent. At 910, the system generates a prompt for determining a query intent based on the access request. At 915, the system prompts the LLM based on the prompt. At 920, the system obtains the query intent from the LLM. At 925, the system provides the query intent. At 930, the system determines whether process 900 is complete. In some embodiments, process 900 is determined to be complete in response to a determination that no further access policies are to be dynamically generated, no further resource access requests are to be processed, no further resources are to be accessed, an administrator indicates that process 900 is to be paused or stopped, etc. In response to a determination that process 900 is complete, process 900 ends. In response to a determination that process 900 is not complete, process 900 returns to 905.

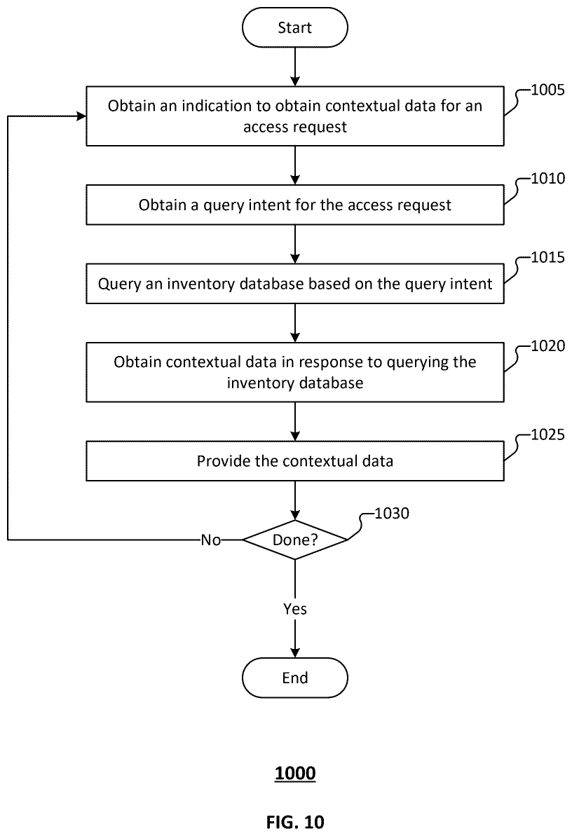

FIG. 10 is a flow diagram of a method for obtaining contextual data according to various embodiments. In some embodiments, process 1000 is implemented at least in part by system 100 of FIG. 1 and/or system 200 of FIG. 2.

In some embodiments, the system enhances the accuracy and relevance of its AI-driven generated access policies by incorporating contextual data retrieved from a structured data store, such as a vector database (e.g., comprising vectors that are representations of data stored in a knowledgebase). This contextual data helps the AI (e.g., the LLM) refine its understanding of the access request and ensures that the generated policies align with enterprise security requirements and operational needs. By leveraging vector representations of enterprise network knowledge, the system dynamically retrieves and integrates the most relevant information to guide access policy generation.

To obtain this contextual data, the system can rely on a vector database that stores encoded representations of enterprise network knowledge. According to various embodiments, this knowledge base includes information about one or more of cloud services, infrastructure resources, access control models, and user roles. Instead of retrieving static policy templates, the system performs similarity searches within the vector database to locate contextually relevant data points that match the user's access request. These vectors are generated using embedding models trained on structured and unstructured enterprise data, allowing the system to capture complex relationships between resources, users, and access control frameworks.

When a user submits an access request, the system queries the vector database to retrieve contextual data related to the requested resources. As an example, the retrieved vectors provide a semantic representation of related services, infrastructure components, and prior access patterns. For example, if a user requests access to a cloud-based database, the system may retrieve vectors representing access control policies for one or more of similar databases, dependencies on related storage or compute resources, and/or historical permissions granted for similar tasks. This ensures that the generated access policy is not only specific to the requested resource but also takes into account the broader network context.

The contextual data retrieval process can also consider real-time system conditions. For example, if the infrastructure has recently changed (e.g., such as new services being deployed or old resources being deprecated, or resource configurations being changed, etc.) the system updates the vector representations to reflect these modifications. For example, the system implements one or more embedding models to analyze the current knowledgebase and to generate the set of vectors for this network. This enables the system (e.g., the AI/LLM deployed at the AI backend) to generate policies that are always in sync with the current enterprise environment, preventing outdated or overly permissive access grants. By continuously updating the vector representations, the system ensures that access decisions remain accurate and aligned with evolving security requirements.

In some embodiments, once the relevant contextual data is retrieved, the system augments the LLM's prompt with this information before generating the access policy. This augmentation process provides the system (e.g., the AI/LLM deployed at the AI backend) with additional insights, such as the user's existing permissions, security policies for the requested resource(s), and compliance requirements applicable to the access request. In some embodiments, if the system detects that the requested access is similar to prior approved requests, it may adjust the generated policy to align with established best practices while maintaining strict adherence to the principle of least privilege.

By integrating contextual data retrieval with AI-driven policy generation, the system ensures that access decisions are both precise and dynamically responsive to the organization's security landscape. The use of embedding models and vectorized representations allows for efficient, scalable, and context-aware policy generation, enabling enterprises to enforce access control policies that adapt to real-time needs while maintaining strong security and compliance standards.

Returning to the example shown, at 1005, the system obtains an indication to obtain contextual data for an access request. At 1010, the system obtains a query intent for the access request. At 1015, the system queries an inventory database based on the query intent. At 1020, the system obtains contextual data in response to querying the inventory database. At 1025, the system provides the context data. At 1030, the system determines whether process 1000 is complete. In some embodiments, process 1000 is determined to be complete in response to a determination that no further access policies are to be dynamically generated, no further resource access requests are to be processed, no further resources are to be accessed, an administrator indicates that process 1000 is to be paused or stopped, etc. In response to a determination that process 1000 is complete, process 1000 ends. In response to a determination that process 1000 is not complete, process 1000 returns to 1005.

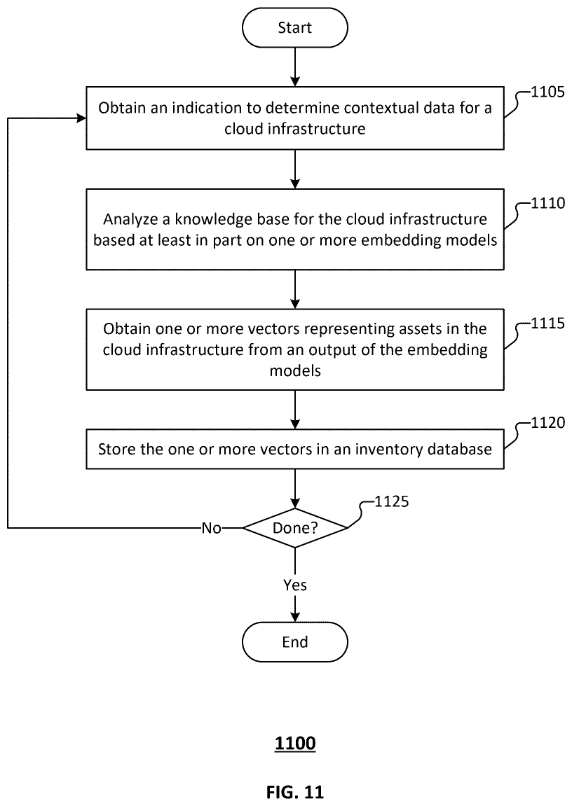

FIG. 11 is a flow diagram of a method for storing contextual data into a data store based on information stored in an enterprise network knowledge base according to various embodiments. In some embodiments, process 1100 is implemented at least in part by system 100 of FIG. 1 and/or system 200 of FIG. 2.

According to various embodiments, the system employs a sophisticated mechanism for analyzing a knowledge base that comprises information on multi-cloud inventories, including service and infrastructure resources information. Various cloud inventory tools provide techniques to extract/download cloud inventory in structured formats such as JSON or XML. This structured inventory data can be stored in the knowledge base. This knowledge base serves as a foundational dataset that enables the system to dynamically determine contextual data necessary for generating access policies. By leveraging AI-driven techniques, the system ensures that the most relevant and up-to-date information is retrieved and incorporated into the access decision-making process. One of the key methods used for processing this knowledge base is the deployment of embedding models, which allow the system to extract meaningful insights and relationships from large, complex datasets.

An example of a structured inventory data includes: {“service”: “EC2”, “instance_id”: “i-0abcd1234efgh5678”, “instance_type”: “t2.medium”, “region”: “us-east-1”, “ami_id”: “ami-0abcdef1234567890”, “state”: “Running”, “public_ip”: “54.123.45.67”, “private_ip”: “10.0.1.1”, “tags”: {“Name”: “WebServer”, “Environment”: “Production”, “Service”: “alpha_webserver”}, “launch_time”: “2025-03-25T10:00:00Z”}.

An example of a structured inventory data includes: {“service”: “RDS”, “db_instance_id”: “mydb-instance-01”, “db_instance_class”: “db.t2.medium”, “engine”: “mysql”, “region”: “us-east-1”, “availability_zone”: “us-east-1a”, “state”: “Available”, “endpoint”: {“address”: “mydb-instance-01.cle4kjks24gq.us-east-1.rds.amazonaws.com”, “port”: 3306}, “tags”: {“Environment”: “Production”, “Owner”: “DatabaseTeam”, “Service”: “alpha_webserver”}, “backup_retention”: 7, “allocated_storage”: 100}.

In some embodiments, the system uses one or more embedding models to generate structured representations of the knowledge base data by transforming raw information into vectorized formats. These models capture semantic similarities, relationships, and patterns within the data, making it possible for the system to efficiently retrieve relevant contextual information during policy generation.

In some implementations, the system uses one or more pre-trained natural language processing (NLP) embeddings that process textual data describing cloud resources, IAM roles, and service dependencies, converting them into vector representations that can be stored in a vector database. These NLP embeddings allow the system to quickly compare and retrieve relevant data based on similarity searches, significantly improving the speed and accuracy of policy generation.

In some implementations, the system uses one or more domain-specific embeddings that are trained on structured cloud data, including metadata related to cloud services, infrastructure components, and access control policies. These domain-specific embeddings capture dependencies between different cloud resources, allowing the system to determine which permissions are necessary based on a user's request. For example, if a user requests access to a cloud-based database, the system can analyze the vectorized representation of that database and identify related resources such as storage, network configurations, and encryption settings, ensuring that access is granted in a comprehensive yet secure manner.

The embedding models can also be used to generate hierarchical representations of cloud resources, enabling more granular access control decisions. By organizing service and infrastructure components into multi-dimensional embeddings, the system can determine which permissions should be granted at different levels of access. For instance, if a user requires access to an application running on a virtual machine, the system can use hierarchical embeddings to determine whether access should be granted at the instance level, the container level, or the application level, ensuring precision in access policy generation.

In some embodiments, a further refinement of the embedding process involves contextual embeddings that incorporate real-time session data. These models can dynamically adjust vector representations based on live contextual inputs, such as the user's role, prior access patterns, and the security posture of the cloud environment. This ensures that the system does not rely solely on static knowledge but instead adapts to changes in infrastructure and user behavior. The contextual embeddings enable the system to make informed access decisions that align with current security policies and operational requirements.

By leveraging embedding models to structure and analyze the knowledge base, the system achieves an advanced level of contextual awareness in access management. The ability to store and retrieve data in a vectorized format enhances efficiency, while the use of hierarchical and contextual embeddings ensures that permissions are granted in a precise and adaptive manner. This AI-driven approach allows the system to navigate complex multi-cloud environments seamlessly, providing secure, scalable, and intelligent access control tailored to organizational needs.

According to various embodiments, the system ensures that the contextual data used for generating access policies remains accurate and reflective of the current state of the enterprise network by continuously updating the data store, such as a vector database. These updates are used to maintain precise access control decisions as the network evolves with new resources, reconfigurations, and policy changes. By dynamically refreshing vector representations, the system ensures that access requests are evaluated against the most up-to-date information, preventing outdated permissions and improving security compliance.

One approach the system can use to update the vectors is event-driven updates, where the system detects changes in the enterprise network and triggers updates to the corresponding vector representations. When a new resource, such as a virtual machine, database, or microservice, is deployed, the system recognizes this addition and generates new vector representations that reflect its access requirements, dependencies, and associated policies. According to various embodiments, tagging resources is a technique implemented to group the cloud resources together logically. For example, if a new component has been introduced to alpha_webservice, the system tags all the resources specific to alpha_webservice with a defined tag, so as to logically group the components/resources. During retrieval the system can query for resources or resource information based on a tag. In addition, the system can tag production, development, quality assurance (QA), stage resources, so that based on the user/query intent, the can appropriate retrieve resources matching the tag. Similarly, when resources are decommissioned or access policies are modified, the system updates the corresponding vectors to remove or adjust outdated references. This event-driven mechanism ensures that the knowledge base remains current without requiring manual intervention.

Additionally or alternatively, the system can update the vector database at predefined intervals. Through scheduled updates, the system periodically scans the enterprise environment to detect any modifications such as those that may not have been captured through event-driven triggers (e.g., in the case that an event-driven update mechanism is implemented). These scheduled updates help maintain the integrity of the data store by ensuring that even subtle changes, such as minor security policy adjustments or permission refinements, are reflected in the vector representations. In some embodiments, the system combines real-time (e.g., event-driven) and periodic updates to achieve a comprehensive approach to keeping contextual data relevant and up to date.

The process of updating the vector database involves analyzing the modified data and generating new embeddings that capture the latest state of the enterprise environment. The system employs embedding models to process the updated information, converting changes into new vector representations that are indexed within the database. This re-embedding process ensures that all queries made to the system retrieve the most accurate and contextually relevant information when generating access policies. If a previous vector representation is no longer valid due to resource decommissioning or access policy revocation, the system removes or replaces it to prevent outdated information from influencing access decisions. In some implementations, in response to determining that a vector representation is no longer valid (e.g., due to changes in the services or infrastructure) the system flags the vector representation as being invalid or inactive, etc.

By continuously maintaining the accuracy of its contextual data store, the system enhances its ability to generate precise and compliant access policies. Keeping the vector database in sync with enterprise infrastructure and security policies ensures that access control decisions reflect the latest configurations and security mandates. This dynamic updating process enables the system to provide highly adaptive and secure access management, reducing the risk of granting excessive or outdated permissions while maintaining efficiency in processing user access requests.

Returning to the example shown, at 1105, the system obtains an indication to determine contextual data for a cloud infrastructure. At 1110, the system analyzes a knowledge base for the cloud infrastructure based at least in part on one or more embedding models. At 1115, the system obtains one or more vectors representing assets in the cloud infrastructure from an output of the embedding models. At 1120, the system stores the one or more vectors in an inventory database. At 1125, the system determines whether process 1100 is complete. In some embodiments, process 1100 is determined to be complete in response to a determination that no further resources are to be characterized, an administrator indicates that process 1100 is to be paused or stopped, etc. In response to a determination that process 1100 is complete, process 1100 ends. In response to a determination that process 1100 is not complete, process 1100 returns to 1105.

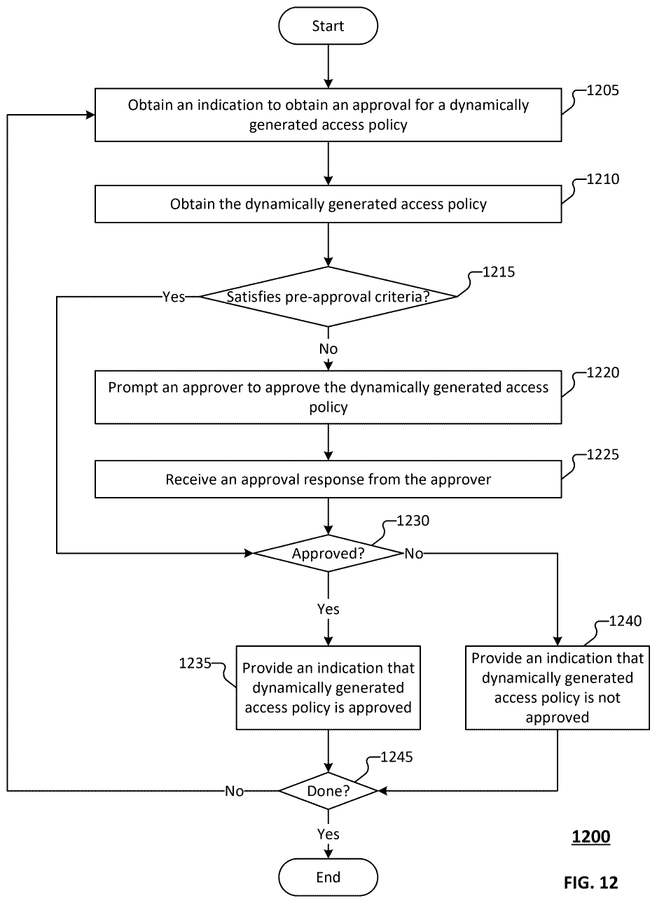

FIG. 12 is a flow diagram of a method for obtaining approvals for granting access to a resource according to various embodiments. In some embodiments, process 1200 is implemented at least in part by system 100 of FIG. 1 and/or system 200 of FIG. 2.

According to various embodiments, the system includes an access manager module or service that is responsible for enforcing, approving, and managing the lifecycle of access requests and/or access policies. This access manager service ensures that dynamically generated access policies are properly stored, tracked, and enforced in accordance with organizational security requirements. When an access policy is generated, it is stored in a centralized database along with relevant metadata such as the session ID, user details, service or resource information, and expiration parameters. This centralized tracking enables visibility into access requests (and subsequent accessing of the applicable resources in accordance with the generated access policy) and allows for efficient auditing and compliance monitoring.

In some embodiments, the system (e.g., the access manager service) implements an approval mechanism. For example, this approval mechanism can be implemented for higher-risk or more sensitive access requests. When an access request falls into a category that requires additional scrutiny (e.g., such as requests for privileged system resources, administrative functions, personal data, or confidential data or other sensitive data) the system triggers an approval workflow. The system can prompt an approver to approve the pending access grant (e.g., the dynamically generated access policy for the access request). As an example, project owners, administrators, or designated security personnel review the request and determine whether access should be granted. The approval process may involve additional verification steps, such as multi-factor authentication (MFA) or justification from the user explaining the reason for access. This ensures that critical resources are protected from unauthorized access and that only necessary permissions are granted.

In some embodiments, the system can implement a pre-approval mechanism. For standard or lower-risk access requests, the system (e.g., the access manager service) can grant access automatically based on predefined policies and user privileges. If a user has existing permissions or role-based entitlements that align with the requested access, the system can instantly approve and apply the relevant access policy without requiring human intervention. This pre-approval mechanism streamlines workflows for common tasks, such as developers accessing logging data or engineers needing short-term permissions for debugging purposes. By dynamically evaluating the user's privileges against the requested resource, the system ensures that access remains tightly controlled while minimizing unnecessary administrative overhead.

In some embodiments, the system (e.g., the access manager service) integrates directly with cloud identity and access management (IAM) systems, including AWS IAM, Azure AD, and Google Cloud Platform IAM, to enforce granted policies. Once an access request is approved or automatically granted, the system applies the corresponding roles and permissions to the user's session, ensuring that they have the appropriate level of access within the cloud environment. This integration enables real-time enforcement of policies and allows for seamless interaction between the access management framework and cloud-native security controls.

Returning to the example shown, at 1205, the system obtains an indication to obtain an approval for a dynamically generated access policy. At 1210, the system obtains the dynamically generated access policy. At 1215, the system determines whether the dynamically generated access policy satisfies a pre-approval criteria. In response to determining that the generated access policy does not satisfy the pre-approval criteria, process 1200 proceeds to 1220. Conversely, in response to determining that the generated access policy satisfies the pre-approval criteria, process 1200 proceeds to 1230. At 1220, the system prompts an approver to approve the dynamically generated access policy. At 1225, the system receives an approval response from the approver. At 1230, the system determines whether the dynamically generated access policy is approved, for example, based on a pre-approval or a manual approval received from an approver. In response to determining that the dynamically generated access policy is approved at 1230, process 1200 proceeds to 1235 at which the system provides an indication that dynamically generated access policy is approved. Conversely, in response to determining that the dynamically generated access policy is not approved at 1230, process 1200 proceeds to 1240 at which the system provides an indication that the dynamically generated access policy is not approved. At 1245, the system determines whether process 1200 is complete. In some embodiments, process 1200 is determined to be complete in response to a determination that no further access policies are to be dynamically generated, no further resource access requests are to be processed, no further resources are to be accessed, an administrator indicates that process 1200 is to be paused or stopped, etc. In response to a determination that process 1200 is complete, process 1200 ends. In response to a determination that process 800 is not complete, process 1200 returns to 1205.

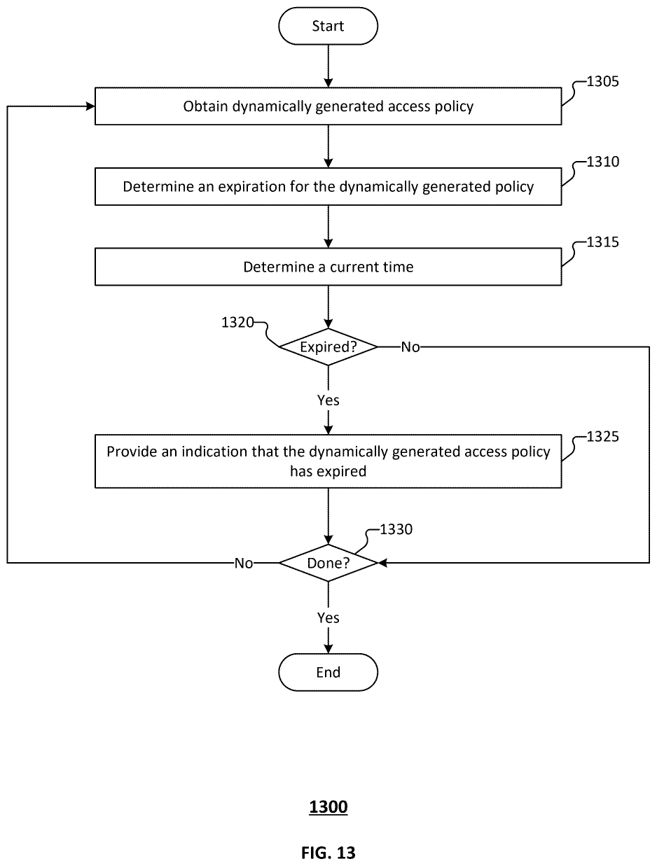

FIG. 13 is a flow diagram of a method for enforcing a time boundary for an access policy according to various embodiments. In some embodiments, process 1300 is implemented at least in part by system 100 of FIG. 1 and/or system 200 of FIG. 2.

In some embodiments, the system utilizes an access manager service to ensure that granted permissions remain active only for the necessary duration, preventing stale or excessive access. The access manager service can continuously track the session lifecycle, monitoring the duration of the user's access and the specific task being performed. Once the session concludes or the predefined time-to-live (TTL) associated with the policy expires, the system takes action to revoke the granted permissions. This expiration mechanism enforces the principle of least privilege by ensuring that access does not persist beyond what is required.

When an access policy is set to expire, the access manager service can take multiple approaches to enforce expiration. In some embodiments, the system (e.g., access manager service) proactively deletes the policy from the cloud IAM system, removing the user's ability to access the associated resources. In some embodiments, if the access was granted through role-based access control (RBAC), the system (e.g., access manager service) may revoke the assigned role, detaching the user from the permissions granted during the session. In cases where policies cannot be deleted outright, the system (e.g., access manager service) may modify the policy to restrict or nullify permissions, effectively rendering the access non-functional.

In some embodiments, the expiration process comprises real-time event-driven triggers to ensure immediate revocation. For example, if the system detects that the user has completed their assigned task earlier than expected, the system (e.g., the access manager service) can revoke access before the TTL elapses. Additionally, or alternatively, if the system monitors inactivity or detects anomalies suggesting that the session is no longer active, the system (e.g., the access manager service) can automatically expire the associated permissions to minimize security risks. These real-time checks ensure that access remains dynamic and responsive to user behavior rather than relying solely on fixed expiration windows.

In scenarios where a user requires an extension beyond the originally granted timeframe, the system (e.g., the access manager service) provides a structured renewal mechanism. Before revoking access, the system may prompt the user to confirm whether they still require access. If the user submits a renewal request, the system can either automatically extend access based on predefined rules or trigger an approval workflow for administrators to review. If the renewal request is denied or if the user does not respond within a certain period, the system proceeds with revocation, ensuring that access does not persist unnecessarily.

The system can significantly reduce the risk of unauthorized access and minimize administrative burden by automating the expiration and revocation of access policies. Users receive access only for the duration required to complete their tasks, and permissions are promptly revoked when no longer needed. This technique enhances security, ensures compliance with access control policies, and prevents privilege accumulation that could lead to potential security vulnerabilities in cloud and enterprise environments.

Returning to the example shown, at 1305, the system obtains a dynamically generated access policy. At 1310, the system determines an expiration for the dynamically generated policy. At 1315, the system determines a current time. At 1320, the system determines whether the dynamically generated policy is expired. In response to determining that the dynamically generated policy is expired, process 1300 proceeds to 1325 at which the system provides an indication that the dynamically generated access policy has expired. Conversely, in response to determining that the dynamically generated access policy is not expired, process 1300 proceeds to 1330. At 1330, the system determines whether process 1300 is complete. In some embodiments, process 1300 is determined to be complete in response to a determination that no further access policies are to be dynamically generated, no further resource access requests are to be processed or evaluated, no further resources are to be accessed, an administrator indicates that process 1300 is to be paused or stopped, etc. In response to a determination that process 1300 is complete, process 1300 ends. In response to a determination that process 1300 is not complete, process 1300 returns to 1305.

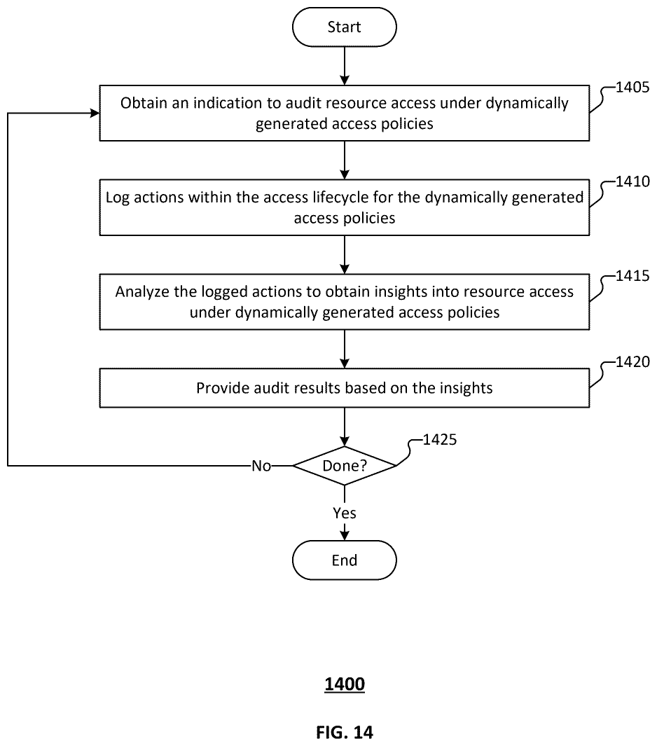

FIG. 14 is a flow diagram of a method for auditing resource access under dynamically generated access policies according to various embodiments. In some embodiments, process 1400 is implemented at least in part by system 100 of FIG. 1 and/or system 200 of FIG. 2.

In some embodiments, the system comprises an audit and compliance service that centralizes the logging and monitoring of all user access-related activities. For example, every access request, policy generation, permission grant, and subsequent revocation is recorded in a centralized audit log. The system can ensure full traceability and visibility into how resources are accessed and managed across cloud environments by maintaining a comprehensive record of all access transactions. This centralized approach enables organizations to track user actions in real time, detect potential security threats, and ensure compliance with internal policies and regulatory requirements.

In some embodiments, in connection with implementing an auditing service, the system records detailed metadata for each logged event. As an example, entry includes information such as one or more of the user identity, the requested resource, the permissions granted, the duration of access, the approval status, and any modifications made to the access policy. In addition, contextual information, such as the user's device, location, and session attributes, can be logged to provide further insight into the access event. By capturing this level of detail, the system allows security teams to conduct thorough investigations into access patterns and detect anomalies that may indicate unauthorized access attempts or policy misconfigurations.

In some embodiments, the audit and compliance service also supports automated compliance checks, helping organizations adhere to security standards and regulatory frameworks such as GDPR, HIPAA, and SOC 2. The system can periodically analyze the audit logs to identify deviations from best practices, such as excessive privilege assignments, long-lived permissions, or access granted without proper approval. If a compliance issue is detected, the system can generate alerts or trigger corrective actions, such as revoking unnecessary access or prompting an administrator to review policy changes. This proactive approach helps mitigate security risks and ensures that access control policies align with industry standards and organizational requirements.

In addition to compliance monitoring, the system enables real-time security monitoring by integrating with security information and event management (SIEM) platforms. The system can forward audit logs to a SIEM system, thereby enabling security teams to correlate access data with other security events to detect potential threats, such as insider attacks or unauthorized privilege escalations. In some embodiments, the system (or the SIEM platform) analyzes the audit logs using machine learning algorithms to identify unusual access behaviors, such as users requesting permissions outside their normal usage patterns, helping to strengthen overall security posture.

In some embodiments, the audit log serves as a centralized, immutable record of all access-related activities. By maintaining this audit log, the system enhances transparency and accountability within an organization. Security teams, auditors, and compliance officers can easily review historical access records to understand who accessed which resources and why. This level of traceability not only simplifies security audits but also provides a foundation for refining access control policies based on real-world usage patterns. The system uses the audit and compliance service to ensure that access governance remains robust, secure, and aligned with evolving security and compliance needs.

Returning to the example shown, at 1405, the system obtains an indication to audit resource access under dynamically generated access policies. At 1410, the system logs actions within the access lifecycle for the dynamically generated access policies. At 1415, the system analyzes the logged actions to obtain insights into resource access under dynamically generated access policies. At 1420, the system provides audit results based on the insights. At 1425, the system determines whether process 1400 is complete. In some embodiments, process 1400 is determined to be complete in response to a determination that no further access policies are to be dynamically generated, no further resource access events are to be monitored or logged, no further dynamic access policy generation services are to be trained or updated, an administrator indicates that process 1400 is to be paused or stopped, etc. In response to a determination that process 1400 is complete, process 1400 ends. In response to a determination that process 1400 is not complete, process 1400 returns to 1400.

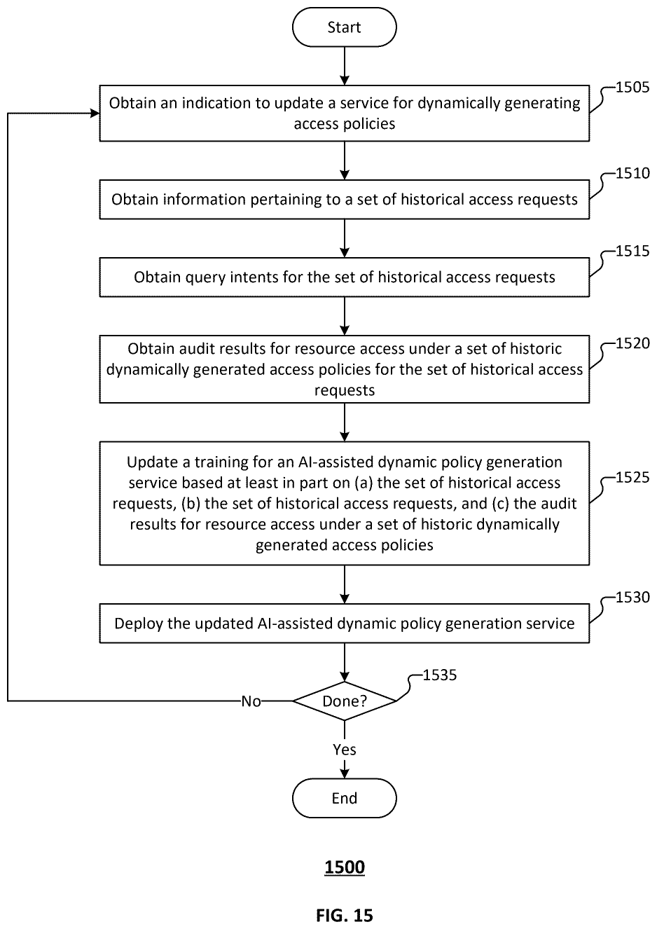

FIG. 15 is a flow diagram of a method for updating a service for dynamic generation of access policies according to various embodiments. In some embodiments, process 1500 is implemented at least in part by system 100 of FIG. 1 and/or system 200 of FIG. 2.

In some embodiments, the system incorporates a feedback loop that continuously improves the system's (e.g., the AI backend service) ability to process access requests with greater accuracy and efficiency. By leveraging audit logs and historical access data, the system refines its policy generation capabilities over time, ensuring that access requests are processed with a deeper understanding of user behavior, access scope, and security requirements. This iterative learning technique allows the system (e.g., the AI backend service) to adapt dynamically to evolving access patterns, reducing unnecessary permission grants while maintaining seamless user access to required resources.

As users interact with the system, all access requests, approvals, policy changes, and revocations are logged in a centralized audit repository. The system (e.g., the AI backend service) periodically (or in response to a request to update/retrain the AI backend service) analyzes these logs to identify trends and patterns in how permissions are granted and used. As an example, if the system detects that a user frequently requests access to the same set of resources for a recurring task, the system (e.g., the AI backend service) may adjust future access policy generation to streamline approvals while maintaining security constraints. Conversely, if a user is consistently granted access to resources the user rarely uses, the system (e.g., the AI backend service) can refine its policy generation to reduce unnecessary permissions, ensuring adherence to the principle of least privilege.

The feedback mechanism also enables the system to adjust access durations based on real-world usage data. For example, if audit logs reveal that certain types of access are consistently used for shorter durations than initially allocated, the system (e.g., the AI backend service) can modify future policies to grant access for only the necessary time, thereby reducing the risk of prolonged permissions. Similarly, if users frequently request extensions for specific tasks, the system (e.g., the AI backend service) can anticipate these needs and suggest appropriate default durations based on historical patterns, reducing the need for manual intervention.

By incorporating compliance insights from audit logs, the system (e.g., the AI backend service) enhances policy enforcement in alignment with security best practices and regulatory requirements. For example, if patterns of non-compliant access behavior are detected (e.g., such as permissions being granted without proper approvals or users frequently requesting excessive privileges), the system (e.g., the AI backend service) can adjust its policy recommendations to enforce stricter controls. In some embodiments, the system learns from administrative interventions, such as access revocations or modifications made by security teams, and incorporates these adjustments into future policy generation to prevent similar over-permissioning scenarios.

In some embodiments, the feedback technique extends beyond individual user behavior to account for broader organizational trends. The system (e.g., the AI backend service) can analyze access requests across teams and departments to detect inefficiencies in existing access control structures. If certain roles or projects consistently require specific access permissions, the system can recommend pre-approved policy templates to streamline access requests while maintaining security controls. Additionally, the system (e.g., the AI backend service) can adapt to infrastructure changes, such as new cloud services or resource configurations, ensuring that access policies remain relevant as the enterprise environment evolves.

The use of continuously learning from historical access data, administrative decisions, and compliance insights enables the system to ensure that AI-driven access policy generation becomes more precise and efficient over time. This adaptive approach not only improves the user experience by reducing friction in access approvals but also strengthens security by proactively refining permissions based on real-world usage. Through an intelligent feedback mechanism, the system (e.g., the AI backend service) evolves to provide access control that is both dynamic and context-aware, minimizing security risks while optimizing operational efficiency.

Returning to the example shown, at 1505, the system obtains an indication to update a service for dynamically generating access policies. At 1510, the system obtains information pertaining to a set of historical access requests. At 1515, the system obtains query intents for the set of historical access requests. At 1520, the system obtains audit results for resource access under a set of historic dynamically generated access policies for the set of historical access requests. At 1525, the system updates a training or configuration for an AI-assisted dynamic policy generation service based at least in part on (a) the set of historical access requests, (b) the set of historical access requests, and (c) the audit results for resource access under a set of historic dynamically generated access policies. At 1530, the system deploys the updated AI-assisted dynamic policy generation service. At 1535, the system determines whether process 1500 is complete. In some embodiments, process 1500 is determined to be complete in response to a determination that no further access policies are to be dynamically generated, no an administrator indicates that process 1500 is to be paused or stopped, etc. In response to a determination that process 1500 is complete, process 1500 ends. In response to a determination that process 1500 is not complete, process 1500 returns to 1505.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine, using an AI-powered dynamic decision-making model, access decisions for user authorization for each of a plurality of cloud providers for an enterprise; and
automatically provision access to a user based on the determined access decisions for user authorization for each of the plurality of cloud providers; and
a memory coupled to the one or more processors and configured to provide the one or more processors with instructions.

2. The system of claim 1, wherein a provisioned access is time limited.

3. The system of claim 1, wherein the provisioned access is expired after a predefined period of time has lapsed.

4. The system of claim 1, wherein the AI-powered dynamic decision-making model is a large language model (LLM).

5. The system of claim 4, wherein:
the one or more processors are further configured to:
receive a request from a user for access to one or more network resources; and
determining the access decisions for user authorizations comprises querying the LLM for the access decisions based at least in part on the request.

6. The system of claim 5, wherein the LLM determines the access decisions based at least in part on inferring an intent associated with the user, and obtaining context data associated with the request.

7. The system of claim 6, wherein the context data is obtained based at least in part on information stored in a knowledge base.

8. The system of claim 7, wherein the knowledge base stores cloud resource information and cloud-specific information.

9. The system of claim 7, wherein the knowledge base stores multi-cloud inventor information and identity.

10. The system of claim 7, wherein the context data is obtained based at least in part on querying a cloud inventory object database that stores representations for the information stored in the knowledge base.

11. The system of claim 7, wherein the context data comprises Retrieval-Augmented Generation (RAG)-augmented information, and the context data is used to provide more context to the LLM for inference of the access decisions for user authorization associated with the request.

12. The system of claim 7, wherein the knowledge base stores one or more tags associated with one or more resources associated with at least one of the plurality of cloud providers.

13. The system of claim 1, wherein:
the AI-powered dynamic decision-making model comprises a large language model (LLM); and
automatically provisioning access to the user comprises:
querying a large language model (LLM) to create an access policy for one or more resources associated with at least one of the plurality of cloud providers.

14. The system of claim 13, wherein access policy is an identity and access management (IAM) policy.

15. The system of claim 1, wherein automatically provisioning access comprises granting just in time access to a resource in real time in response to a request to access the resource.

16. The system of claim 1, wherein automatically provisioning access comprises granting a time-bound access to a resource after a request to access the resource is approved.

17. The system of claim 1, wherein automatically provisioning access for a user comprises adapting permissions over time as user requirements change.

18. The system of claim 1, wherein automatically provisioning access for a user comprises determining the user's existing permissions based on permissions store d in an access database, and grants access to user based at least in part on the user's existing permissions.

19. The system of claim 1, wherein automatically provisioning access for a user comprises (a) generating an access policy, (b) prompting an administrator to approve a granting of the access policy, and (c) in response to receiving an indication that the administrator approves the granting of the access policy, provision access to the user according to the access policy.

20. A method, comprising:
determining, using an AI-powered dynamic decision-making model, access decisions for user authorization for each of a plurality of cloud providers for an enterprise; and
automatically provisioning access to a user based on the determined access decisions for user authorization for each of the plurality of cloud providers.

21. A computer program product embodied in a non-transitory computer readable medium and comprising computer instructions for:
determining, using an AI-powered dynamic decision-making model, access decisions for user authorization for each of a plurality of cloud providers for an enterprise; and
automatically provisioning access to a user based on the determined access decisions for user authorization for each of the plurality of cloud providers.

22. A system, comprising:
one or more processors configured to:
receive a request from a user for access to one or more network resources;
generate, based on the request, in real time a policy to allow the user to access the one or more resources; and
provide access to the one or more resources in accordance with the policy; and
a memory coupled to the one or more processors and configured to provide the one or more processors with instructions.

23. The system of claim 20, wherein generating the policy in real time comprises querying, based on the request, a large language model (LLM) to create the policy.

24. The system of claim 21, wherein in response to receiving the query based on the request, the LLM creates the policy based at least in part on:
inferring an intent associated with the request;
obtaining context data associated with the request; and
creating the policy based at least in part on the intent and the context data.

25. The system of claim 22, wherein the LLM obtains the context data associated with the request based at least in part on querying a data store of cloud inventory data for network resources.

26. The system of claim 23, wherein the data store comprises a knowledge based of structured resource data for network resources.
